(19) United States
(12) Patent Application Publication
(10) Pub. No.: US 2022/0311622 A1
(43) Pub. Date: Sep. 29, 2022

(54) SYSTEM AND METHOD WITH ELECTRONIC SIGNATURE SMART ASSIST FEATURE

(71) Applicant: Certinal Software Private Limited, Mumbai (IN)

(72) Inventors: Kanishka Ghosh, Mumbai (IN); Krishnendu Chattopadhyaya, Mumbai (IN)

(73) Assignee: Certinal Software Private Limited, Mumbai (IN)

(21) Appl. No.: 17/682,821

(22) Filed: Feb. 28, 2022

(30) Foreign Application Priority Data
Mar. 25, 2021 (IN) 202121013065

(51) Int. Cl. H04L 9/32

(52) U.S. Cl. CPC H04L 9/3247

(57) ABSTRACT

A system and method with electronic signature smart assist feature including a receiver computer system, a sender computer system, at least one database of the system, wherein the electronic signature smart assist feature of the system on receiving an electronic document for signing, extracts and uploads version of previously negotiated document of the same document for comparison to authenticate data related to key values in these two versions before electronically signing the document and marks deviation if any by a “red flag” and thus alerts the user. The smart assist feature generates and stores metadata for every document for key values as pre-defined by the user, which are then extracted for comparison. These metadata fields are pre-configurable and also editable for addition of new fields.

### CROSS-REFERENCE TO RELATED APPLICATION

The instant application claims priority to Indian Patent Application Serial No. 202121013065, filed Mar. 25, 2021, pending, the entire specification of which is expressly incorporated herein by reference.

### FIELD OF THE INVENTION

The present invention relates to extraction and comparison of data in a document and more particularly it relates to extraction and uploading of key value data in previously negotiated version of documents for comparison to key value data in a new version of the same document before signing it.

### BACKGROUND OF THE INVENTION

Several government, non-government and private organizations around the world have drastically reduced the use of paper to type or print some material and further maintain such hardcopies of document as permanent records. This change is due to the difficulty in maintaining such records which not only occupy huge amount of storage space, but also requires to be maintained adequately for preserving them over a long period of time in good state.

These organizations where huge amount of documentation happens daily have moved to electronic documents that need zero maintenance nor do they occupy much space. These electronic documents once prepared are signed by the authorities, sealed and stored electronically. During the preparation stage of such documents, it is often seen that such documents move to-and-fro between individuals for finalization of content and to check its authenticity too. On receiving its final approval, these documents are sent to the respective high officials for seal/signature, etc.

However, the advent use of electronic documents is seeing its own drawback of document fraud, forgery, etc. Once an author/writer/originator prepares a document and such document is either sent for review or for final signature the receiver cannot guarantee its authenticity with respect to deviation if any from the previous version. Further, it is impossible to check the document word by word for deviation if any manually without human error.

Thus, there arises a need of means that address the problem of auto-alerting user for deviation of data in documents and especially in electronic documents when such documents are sent from one user to another for signature.

US patent document U.S. Pat. No. 7,302,576 describes one-way hash recognition for represented document and assist information. It discloses methods and systems for authenticating documents. Document data to be modified to contain authentication is inputted. A representation is determined from the document data. Assist information that is usable to reliably recover a deters mined representation is determined. A one-way hash of the representation and assist information is determined. The one-way hash is then cryptographically signed. The assist information and digitally signed one-way hash is then appended to the document.

US patent document U.S. Pat. No. 9,268,969 describes a method to search for authentic document when looking at a copy of it for e.g., driving licence requirement by a policeman at signal. This invention relies on e-tags that are put on original document that help the user extract that same document when needed by scanning the e-tag. In this invention a code is added as a marking to a document and encodes an identifier that maps to a copy of the document stored in a database. Database copies of stored documents are preferably digitally signed. Using a device Such as a Smartphone, a user may extract the document identifier from the marking on a purported authentic version of the document and retrieve a copy of the document from the corresponding location in the database. The user can then visually compare the purported authentic version of the document with the retrieved database copy.

US patent document U.S. Pat. No. 6,748,102 evaluates markings in half-tone fields by ascertaining a first dot count of dots isolated from the marking in the half-tone field of the document; forming an image of the marking; superimposing the image on a blank half-tone field having the same predetermined pattern as the half-tone field of the document; ascertaining a second dot count of dots isolated from the image superimposed on the blank half-tone field; and determining whether the marking has been altered by comparing the first dot count to the second dot count. An alteration is indicated where the first dot count and second dot count are different.

None of the prior arts mentioned above solve the problem of alerting a user for deviation if any, related to any key values/key factors as desired by the user before electronically signing the document such that the user can check the authenticity of the document with respect to the previously negotiated version between him and the other user in a comparative manner, and in a way where deviated values are correctly extracted and uploaded for the user to view at a glance.

### OBJECTS OF THE INVENTION

Primary object of the present invention is to authenticate key values/key factors in documents received by a user from another user for signature.

Yet another object of the present invention is to extract and upload previously negotiated version of a document sent to a user from another user between whom the document was previously negotiated.

Yet another object of the present invention is to compare and verify electronic documents before final signature for change/alterations if any to key values from the previously negotiated version.

Yet another object of the present invention is to check altered values, words, numerals in electronic documents as compared to the previously negotiated version.

Yet another object of the present invention is to alert the user for deviations if any from the previously negotiated version of the electronic document before he/she can electronically sign the document by flagging such deviations with a red flag.

### SUMMARY OF THE INVENTION

The present invention is a system and method for electronic signature with smart assist feature for authenticating data in a document comprising of, at least one receiver computer system or mobile device, a sender computer system/mobile device, database for storage. The sender is the one who sends a version of document to a receiver to be signed. The system of the present invention with its smart assist feature, assists the users to authenticate data between previously negotiated and, the present version of the same document, to check veracity of the document pertaining to the key factors/key values as pre-defined by the user before finally signing them and marks deviation if any by a “red flag” and thus alert the user. The smart assist feature generates and stores metadata for every document for key values as pre-defined by the user, which are then extracted for comparison.

### BRIEF DESCRIPTION OF THE DRAWINGS

FIG. 1 depicts work flow of steps performed by the electronic signature smart assist feature to extract and upload two versions of the same document for comparing their key values/key factors.

FIG. 2 depicts work flow of steps for form generation for storing pre-defined metadata fields for a document.

### DETAILED DESCRIPTION OF THE INVENTION

Before the present invention is described, it is to be understood that this invention is not limited to particular methodologies described, as these may vary as per the person skilled in the art. It is also to be understood that the terminology used in the description is for the purpose of describing the particular embodiments only, and is not intended to limit the scope of the present invention. Throughout this specification, the word “comprise”, or variations such as “comprises” or “comprising”, will be understood to imply the inclusion of a stated element, integer or step, or group of elements, integers or steps, but not the exclusion of any other element, integer or step, or group of elements, integers or steps. The use of the expression “at least” or “at least one” suggests the use of one or more elements or ingredients or quantities, as the use may be in the embodiment of the invention to achieve one or more of the desired objects or results. Various embodiments of the present invention are described below. It is, however noted that the present invention is not limited to these embodiments, but rather the intention is that modifications those are apparent are also included.

In the e-commerce industry, electronically signing documents is a very common phenomenon these days. In a company many internal decisions, programs, schemes, rules and regulations are drafted which need to be signed by higher authorities to authorize them before implementation. A very first step of any business relationship is also to sign a document for understanding between the parties. These documents are very important as they form the key basics of the business arrangement between parties and their entire business depends on the clauses as stated in these signed documents.

The present invention is a system and method for electronic signature with smart assist feature for authenticating data in a document comprising of, at least one receiver computer system or mobile device, a sender computer system/mobile device, database for storage. The sender is the one who sends a version of document to a receiver to be signed. The system of the present invention with its smart assist feature, assists the users to authenticate data between previously negotiated and, the present version of the same document, to check veracity of the document pertaining to the key factors/key values as pre-defined by the user before finally signing them.

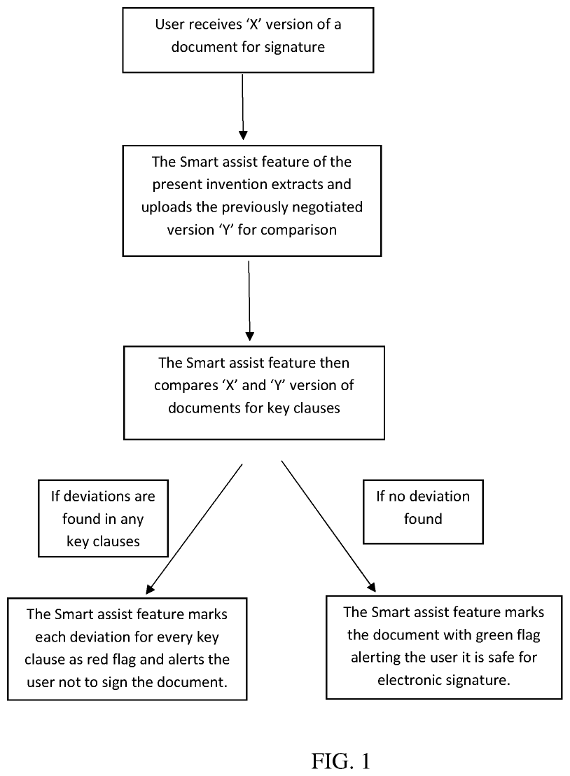

Referring to FIG. 1 in a preferred embodiment of the present invention, a user receives “X” version of a document for signature for which the previous drafted version “Y” is available with the user. The smart assist feature of the system of the present invention is such that it is enabled to extract and upload the previous version “Y” of the same document for comparison. The smart assist feature of the present system then compares “X” and “Y” version of the documents for key clauses/key factors as pre-configured by the user for that document. While comparing the two documents if any deviation is found then the smart assist feature of the system highlights the deviations. The system of the present invention with the smart assist feature raises red flag to each deviated key clause/key factor and thus alerts the users for authenticity of the document helping him decide whether or not to sign the deviated document X. If no deviation is found in any of the key clause/key factor then the system marks the document safe for signing it electronically.

In contract related documents there are certain key clauses or key factors defining the essence of the document. These key clauses or key factors are the core considerations of the document and they define the scope and purpose behind signing such documents before implementation. In the present invention the system of the present invention with its smart assist feature identifies all such key clauses/key factors as metadata. These metadata are user configurable and a user can pre-define set of metadata for a particular document which is then stored in the system of the present invention against the specific document. The system of the present invention with its smart assist feature identifies and compares these metadata fields in a document while assisting a user in determining the authenticity of a document before signing it.

The system of the present invention has set of these pre-configured metadata fields pre-defined by user and stored in storage means like databases. These fields are also configurable as per the need of the user for different contract documents authentication while doing a comparison to authenticate two documents.

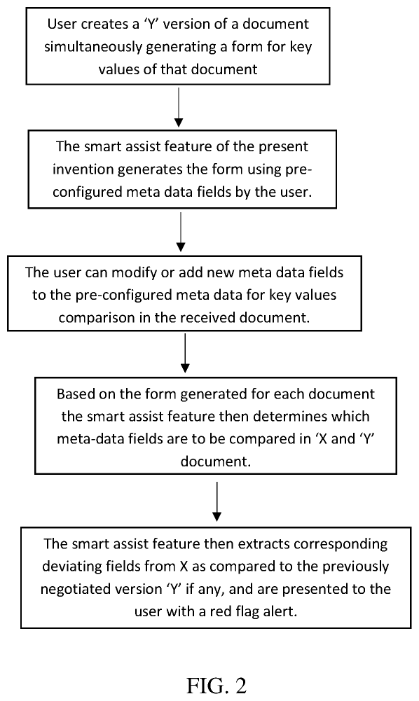

In yet another embodiment of the present invention referring to FIG. 2, users can create a form for metadata fields for key values of any document using the smart assist feature of the present invention. The system of the present invention with smart assist feature generates the form using pre-configured metadata fields as defined by the users. The user can modify or add new metadata fields to the pre-configured metadata field for key values of any document. This data is stored in the metadata field entry of the system. Thus, when a user (receiver) receives a document “X” for electronic signature from the sender and the receiver has a previous version “Y.” The system of the present invention with smart assist feature extracts and uploads the previously negotiated “Y” version of the document for comparison. Based on the pre-configured metadata fields stored the of the present invention with smart assist feature determines which all metadata fields are to be compared in the “X” and “Y” documents and extracts corresponding inputs from the version “X” that deviate from the previously negotiated version “Y” and are presented to the user as alerts marked with a red flag.

The electronic signature smart assist feature of the present invention extracts and uploads corresponding inputs of the fields with deviated metadata based on the heuristic pattern.

The present invention is now being described by way of example; however, it is not to be construed in any manner to limit the scope of the invention.

Consider that a user “A” has negotiated a contract document “Y” with a party “B.” The document Y is with party B for consideration. The party B satisfied with the document and its terms with minor corrections have mailed the document back to A for signature. The system of the user A stores this version of the document as version X (version as received). The system of the present invention allows the user to extract and upload the previously negotiated version “Y” for comparing it with the received version “X” on his computer/laptop/mobile (while working in the electronic signature workflow). The electronic signature with smart assist feature is a novel feature in that; it enables extraction and uploading of the previous versions of required documents for comparing with the received version of the same document within the system of the present invention.

In this example consider the metadata fields as configured by a user A for this contract are:

Limitation of liability

Contract value

Term of contract

Termination

Start date

Expiry date

Renewal term

The smart assist feature of the present invention has extracted following values for these metadata fields from the previous version Y for comparing it with values in X. This process of extraction and uploading of metadata fields by the electronic signature smart assist feature is based on heuristic patterns for the configurable set of metadata fields as defined by the user. The following is the output in this case as extracted for given set of metadata:

| Limitation of liability= | 200,000 USD |
|---|---|
| Contract value | 2bn USD |
| Term of contract | 3 YEARS |
| Termination | No termination for convenience. |
| Start date | January 2021 |
| Expiry date | February 2023 |
| Renewal term | 2 years |
| Price escalation for renewal | 5% |

The present system then compares the extracted metadata fields from the previously negotiated version Y as uploaded and extracted to that of the received version X of the document. In this case the output for X being:

| Limitation of liability= | 100,000 USD |
|---|---|
| Contract value | 2bn USD |
| Term of contract | 3 YEARS |
| Termination | Can terminate at any time |
| Start date | January 2021 |
| Expiry date | February 2023 |
| renewal term | 1 year |
| Price escalation for renewal | 5% |

Since there is major deviation in the metadata field of two versions of the document the system alerts the user by flagging the deviation with a red flag.

| Limitation of liability= | 100,000 USD | deviation |
|---|---|---|
| Contract value | 2bn USD | |
| Term of contract | 3 YEARS | |
| Termination | Can terminate at any time | deviation |
| Start date | January 2021 | |
| Expiry date | February 2023 | |
| renewal term | 1 years | deviation |
| Price escalation for renewal | 5% | |

The system of the present invention with its smart assist feature brings up such critical deviations to the user with alert as red flags that document deviates from the previously negotiated version or its key values and cannot be signed as such.

In some applications, the present invention described above may be provided as elements of an integrated software system, in which the features may be provided as separate elements of a computer program. Some embodiments may be implemented, for example, using a computer-readable storage medium (e.g., non-transitory) or article which may store an instruction or a set of instructions that, if executed by a processor, may cause the processor to perform a method in accordance with the embodiments. Other applications of the present invention may be embodied as a hybrid system of dedicated hardware and software components. Moreover, not all of the features described above need be provided or need be provided as separate units. Additionally, it is noted that the arrangement of the features do not necessarily imply a particular order or sequence of events, nor are they intended to exclude other possibilities. For example, the features may occur in any order or substantially simultaneously with each other. Such implementation details are immaterial to the operation of the present invention unless otherwise noted above.

The exemplary methods and computer program instructions may be embodied on a computer readable storage medium (e.g., non-transitory) that may include any medium that can store information. Examples of a computer readable storage medium (e.g., non-transitory) include electronic circuits, semiconductor memory devices, ROM, flash memory, erasable ROM (EROM), floppy diskette, CD-ROM, optical disk, hard disk, fiber optic medium, or any electromagnetic or optical storage device. In addition, a server or database server may include computer readable media configured to store executable program instructions. The features of the embodiments of the present invention may be implemented in hardware, software, firmware, or a combination thereof and utilized in systems, subsystems, components or subcomponents thereof.

Furthermore, a software program embodying the features of the present invention may be used in conjunction with a computer device or system. Examples of a computing device or system may include, but are not limited to, an electronic book reading device, a computer workstation, a terminal computer, a server computer, a handheld or mobile device (e.g., a tablet computer, a personal digital assistant “PDA,” a mobile telephone, a Smartphone, etc.), a web appliance, a network router, a network switch, a network bridge, any machine capable of executing a sequence of instructions that specify an action to be taken by that machine, and any combinations thereof. In one example, a computing device may include and/or be included in, a kiosk.

As used herein, the term “mobile device” is intended to encompass any form of programmable computing device as may exist, or will be developed in the future, that implements a communication module for wireless voice and data communications, including, for example, cellular telephones, personal data assistants (PDA's), palm-top computers, laptop, and notebook computers, wireless electronic mail receivers (e.g., the BLACKBERRY™ and TREO™ devices), multimedia Internet enabled cellular telephones (e.g., the BLACKBERRY STORM™, and similar personal electronic devices that include a wireless communication module, processor and memory.

The computer device or system may also include an input device. In one example, a user of the computer device or system may enter commands and/or other information into computer device or system via an input device. Examples of an input device may include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. The input device may be interfaced to bus via any of a variety of interfaces including, but not limited to, a serial interface, a parallel interface, a game port, a USB interface, a FIREWIRE interface, a direct interface to bus, and any combinations thereof. The input device may include a touch screen interface that may be a part of or separate from the display.

A user may also input commands and/or other information to the computer device or system via a storage device (e.g., a removable disk drive, a flash drive, etc.) and/or a network interface device. A network interface device, such as network interface device may be utilized for connecting the computer device or system to one or more of a variety of networks and/or one or more remote devices connected thereto. Examples of a network interface device may include, but are not limited to, a network interface card (e.g., a mobile network interface card, a LAN card), a modem, and any combination thereof. Examples of a network may include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software, etc.) may be communicated to and/or from the computer device or system via a network interface device.

The computer device or system may further include a video display adapter for communicating a displayable image to a display device, such as a display device. Examples of a display device may include, but are not limited to, a liquid crystal display (LCD), a cathode ray tube (CRT), a plasma display, a light emitting diode (LED) display, and any combinations thereof. In addition to a display device, the computer device or system may include one or more other peripheral output devices including, but not limited to, an audio speaker, a printer, and any combinations thereof. Such peripheral output devices may be connected to a bus via a peripheral interface. Examples of a peripheral interface may include, but are not limited to, a serial port, a USB connection, a FIREWIRE connection, a parallel connection, and any combinations thereof.

While considerable emphasis has been placed herein on the specific elements of the preferred embodiment, it will be appreciated that many alterations can be made and that many modifications can be made in preferred embodiment without departing from the principles of the invention. These and other changes in the preferred embodiments of the invention will be apparent to those skilled in the art from the disclosure herein, whereby it is to be distinctly understood that the foregoing descriptive matter is to be interpreted merely as illustrative of the invention and not as a limitation.

What is claimed is:

1. A system for authenticating data in a document with an electronic signature smart assist feature, comprising:
a receiver computer system;
a sender computer system; and
at least one database;
wherein the smart assist feature, on receiving an electronic document for signing, extracts and uploads a version of a previously negotiated document of the same document for comparison to authenticate data related to key values in these two versions before electronically signing it.

2. The system as claimed in claim 1, wherein the smart assist feature of the system assists in uploading and comparing two versions of similar documents for key factors or key values and alert users for deviation if any before electronically signing the documents.

3. The system as claimed in claim 1, wherein key factors or key values for each document are stored as set of metadata fields in the database of the system.

4. The system as claimed in claim 1, wherein the smart assist feature compares the key factors or key values stored in a metadata field as extracted from the previously negotiated version based on heuristic patterns.

5. The system as claimed in claim 1, wherein the metadata fields are pre-configured by the users as per the need and are also editable while comparing two versions of the same document.

6. A method for authenticating data in a document with an electronic signature smart assist feature of a system, the system including a receiver computer system, a sender computer system, and at least one database, wherein the smart assist feature, on receiving an electronic document for signing, is operable to extract and upload a version of a previously negotiated document of the same document for comparison to authenticate data related to key values in these two versions before electronically signing it, comprising the steps of:
receiving a version of a document by a user from another user, for which a previously negotiated version exists with the receiver;
accessing the metadata fields to access generated form of metadata field for key values or key factors for comparison;
adding more fields for required key values or key factors for comparison to already present metadata field if required;
extracting and uploading previously negotiated version of the received version of a document for comparison;
comparing metadata fields with the smart assist feature to compare pre-determined metadata fields as generated through the metadata forms;
comparing the received and previous version for deviation if any in the key values or key factors by the smart assist feature of the present invention;
displaying output as a green flag if no deviation; or
displaying output to user as a red flag against each deviated metadata and alerting the user not to sign the document.

7. The method as claimed in claim 6, wherein the smart assist feature of the system assists in uploading and comparing two versions of similar documents for key factors or key values and alert users for deviation if any before electronically signing the documents.

8. The method as claimed in claim 6, wherein key factors or key values for each document are stored as set of metadata fields in the database of the system.

9. The method as claimed in claim 6, wherein the smart assist feature compares the key factors or key values stored in metadata field as extracted from the previously negotiated version based on heuristic patterns.

10. The method as claimed in claim 6, wherein the metadata fields are pre-configured by the users as per the need and are also editable while comparing two versions of the same document.
